(19) United States
(12) Patent Application Publication
(10) Pub. No.: US 2019/0037898 A1
(43) Pub. Date: Feb. 7, 2019

(54) REDUCED FAT CONDIMENTS, PROCESSES AND PRODUCTS

(71) Applicant: MCCORMICK & COMPANY, INCORPORATED, Hunt Valley, MD (US)

(72) Inventors: Wenbo ZHANG, Hunt Valley, MD (US); Yang MENG, Hunt Valley, MD (US); Claudio RATTES, Hunt Valley, MD (US); Stephen LOMBARDO, Hunt Valley, MD (US); Milda EMBUSCADO, Hunt Valley, MD (US)

(73) Assignee: MCCORMICK & COMPANY, INCORPORATED, Hunt Valley, MD (US)

(21) Appl. No.: 16/075,511

(22) PCT Filed: Jan. 27, 2017
(86) PCT No.: PCT/US17/15367

§ 371 Date: Aug. 3, 2018

Related U.S. Application Data
(60) Provisional application No. 62/291,716, filed on Feb. 5, 2016.

(51) Int. Cl. A23L 27/00; A23L 27/60; A23L 29/269; A23L 29/212; A23L 29/10; A23D 7/015; A23D 7/04; A23D 7/01

(52) U.S. Cl. CPC A23L 27/80; A23V 2300/26; A23L 27/88; A23L 29/27; A23L 29/212; A23L 29/10; A23D 7/015; A23D 7/04; A23D 7/011; A23D 7/013; A23V 2002/00; A23V 2200/242; A23V 2200/222; A23V 2200/15; A23V 2250/5118; A23V 2250/5086; A23L 27/60

(57) ABSTRACT

Reduced fat, shelf stable double emulsion condiments. The condiments produced have a reduced fat content, shelf stability, and an enhanced taste profile. The process of making the products is also described.

### CROSS-REFERENCE TO RELATED APPLICATIONS

The present application claims the benefit of U.S. Provisional Application Ser. No. 62/291,716 filed Feb. 5, 2016, the disclosure of which is expressly incorporated by reference herein in its entirety.

### TECHNICAL FIELD

The field of art to which this invention generally pertains is emulsion technology, and specifically edible emulsions.

### BACKGROUND

There is an increasing demand for food products with low and reduced fat content, driven by such things as consumer health and appearance considerations, among others. And although foods with lower fat content can be produced, they can suffer from reduced taste and/or other organoleptic property deficiencies. The substitution of non-fat ingredients for fat-containing ingredients can generate shelf-stability issues as well. Accordingly, there is a constant search in the marketplace for reduced fat foods with organoleptic properties, shelf stability, appearance and other properties associated with their higher fat-containing counterparts.

The embodiments described herein address these challenges.

### BRIEF DESCRIPTION OF THE DRAWINGS

FIG. 1 depicts one representative process embodiment as described herein.

FIGS. 2 and 3 are confocal microscopy photos of representative emulsions as described herein.

FIG. 4 is a representative confocal microscopy photo of a representative, commercially available mayonnaise product.

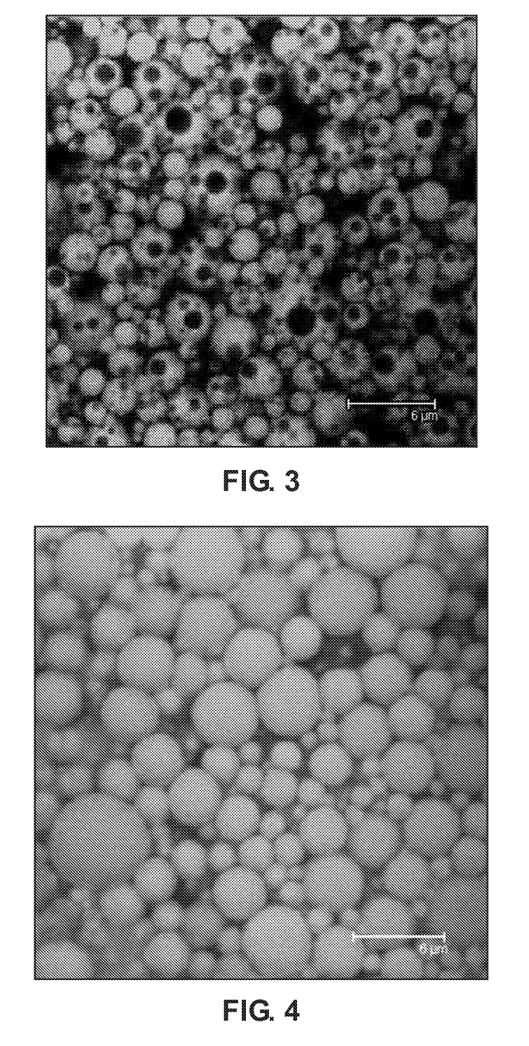

FIG. 5 shows a representative graph of first emulsion water droplets as described herein.

FIG. 6 shows a graph of representative double emulsion oil droplets as described herein.

### BRIEF SUMMARY

A method of making reduced fat condiments is described including preparing a stable water in oil emulsion including adding an emulsifier to an edible oil, adding salt and optionally thickeners and optionally egg yolk to water, adding the water mixture to the oil mixture, adding vinegar to the water mixture either before combining with the oil mixture, and/or to the combined water-oil mixture and processing the water-oil mixture in at least one rotor stator mixer to produce a stable water in oil emulsion. This is followed by preparing a stable water in oil in water emulsion, including mixing a composition including egg yolk and vinegar with the stable water in oil emulsion, and processing the mixture through at least one rotor stator mixer to produce a stable water in oil in water emulsion containing the stable water in oil emulsion. A hydrated hydrocolloid paste composition is also prepared including mixing the hydrocolloid composition with water to produce a hydrated hydrocolloid paste composition, and mixing the hydrated hydrocolloid paste composition with the stable water in oil in water emulsion resulting in a reduced fat, shelf stable condiment with enhanced organoleptic properties.

Additional embodiments include: the method described above where the thickeners comprise edible fibers and/or xanthan gum; the method described above where the rotor stator mixer is a colloidal mill; the method described above where the emulsifier is polyglycerol polyricinoleate, sorbitan monooleate, sorbitan sesquioleate , sorbitan esters with HLB from about 2 to about 6, glycerol monostearate, sorbitan tristerate, propylene glycol monostearate, lecithin, ammonium phosphatide, and/or sucrose ester; the method described above where the stable water in oil emulsion is formed by shearing the water-oil mixture in the at least one rotor stator mixer at a shear rate of about 1×10³ s⁻¹ to about 1×10⁶ s⁻¹ with residence time of less than 3 seconds; the method described above where the stable water in oil in water emulsion containing the stable water in oil emulsion is formed by shearing the water-oil mixture in the at least one rotor stator mixer at a shear rate of about 1×10³ s⁻¹ to about 1×10⁶ s⁻¹ with residence time of less than 3 seconds; the method described above where the shear rate is about 1.3×10⁴ s⁻¹ to about 9.9×10⁴ s⁻¹ with residence time of less than 1 second; the method described above where the shear rate is about 1.2×10⁴ s⁻¹ to about 4.7×10⁴s⁻¹ with residence time of less than 1 second; the method described above where flavoring agents are added after preparation of the water in oil emulsion; and the method described above where the flavoring agents include citrus flavoring agents; the method described above where the citrus flavoring agents comprise lemon juice or lime juice.

Additional embodiments also include: the method described above where the condiment is a reduced fat mayonnaise; the method described above where the reduced fat mayonnaise has a viscosity of about 100,000 to about 200,000 centipoise; the method described above where the reduced fat mayonnaise has a viscosity of at least about 150,000 centipoise; the method described above where the condiment is a reduced fat dressing or sauce; the method described above where the dressing or sauce has a viscosity of below about 60,000 centipoise; the method described above where the dressing or sauce has a viscosity of about 20,000 to about 50,000 centipoise; the method described above where the dressing or sauce is a reduced fat salad dressing, sandwich spread, or tartar sauce; the method described above where the dressing or sauce has a viscosity above about 50,000 centipoise; the method described above where the dressing or sauce has a viscosity about 60,000 to about 150,000; the method described above where the edible fiber is citrus fiber; the method described above where the hydrocolloid is a modified starch; the method described above where the hydrocolloid comprises one or more fibers, gums and/or starches; and the method described above where the hydrated hydrocolloid paste additionally contains salt, sugar, citrus fiber and/or preservatives.

Additional embodiments also include: the method described above where the stable water in oil emulsion contains water droplets have an average diameter of about 0.5 micron to about 3 microns; the method described above where the water in oil in water emulsion contains oil droplets having an average diameter of about 5 microns to about 15 microns; the method described above where the condiment produced has an oil content of less than 65% by weight; the method described above where the condiment produced has an oil content of 40% or less by weight; the method described above where the condiment produced has an oil content of 30% or less by weight; the method described above where the condiment produced has an oil content of 20% or less by weight; the method described above where edible fiber is added to either the first emulsion or the second emulsion or both; the method described above where the edible fiber is citrus fiber; the method described above where the water content in the first water in oil emulsion is about 10% to about 45% by volume; the method described above where the condiment is mayonnaise, having a viscosity of about 150,000 centipoise, the oil is present in an amount of about 20% by weight, and the emulsifier is polyglycerol polyricinoleate present in an amount of about 0.15% to 0.28% by weight.

A reduced fat condiment product produced by the method described above is also described.

These and additional embodiments are further described below.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms“a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

Current reduced fat condiments, such as sauces and dressings, generally rely on replacing some of the oil with water-soluble ingredients, such as modified starches, that increase the viscosity of the emulsion continuous phase. However, if the oil content is too low it will result in a “starchy” mouth-feel and thus, in the eye of the consumer, an inferior product.

An alternate approach is to utilize double emulsion technology as described herein for producing such products, the benefits and advantages of which are especially demonstrated and highlighted in the production of reduced fat mayonnaise products, among others. Water-in-oil-in-water (w/o/w) emulsion, for instance, have been known to the food industry for many years. Numerous research papers and review articles have been published, highlighting the potential of double emulsions for improving food product quality or functional properties.

Double emulsion technology has been studied widely (see, for example, US published patent applications Nos. 2008/0044543 and 2010/0233221, and “Processing of double emulsions”, Axel Syrbe, SCI Conference, Science & Technology of Food Emulsions, Jun. 22,2012, the disclosures of which are herein incorporated by reference. Most solutions proposed to date rely on the usage of polyglycerol polyricinoleate (PGPR) and other emulsifiers in water in oil emulsion. But the amount used are much higher than FDA allowed usage level for condiments (0.28% maximum in condiments) and no double emulsion-based food products appear to be currently present in the marketplaces. One reason, among others, may be that double emulsion has demonstrated poor stability and relative short shelf life. The processes and products described herein produce reduced fat condiments, and in particular mayonnaise, with w/o/w emulsion technology, overcoming poor stability and short shelf life deficiencies with FDA allowed usage level of emulsifiers and shortcomings among other things. In addition, the use of the w/o/w emulsion technology as described herein, including modified starch, also results in a significant (e.g., about 75%) fat reduction with substantially the same desirable appearance, texture, mouth feel, etc. as their full fat, commercially available counterparts. Ingredients used and process details are demonstrated below.

The products produced herein can be produced in a range of viscosities, and advantageously, can maintain these viscosities, especially the higher (thicker) viscosity levels, over time, e.g., “on the shelf”. For example, for reduced fat mayonnaise and similar applications as described herein, stable viscosity levels of about 100,000 to about 200,000 centipoise, and typically at least about 150,000 centipoise, can be attained. However, for “creamier” applications, such as sauces and dressings, stable viscosity levels below about 60,000 centipoise, and typically about 20,000 to about 50,000 centipoise, can be attained. The creamier applications can also include, for example, salad dressings and sandwich spreads (e.g., with viscosities typically above about 50,000 centipoise), and tartar sauce and sandwich spreads (e.g., with viscosities typically around 60,000 to around 150,000 centipoise), etc.

### EXAMPLE

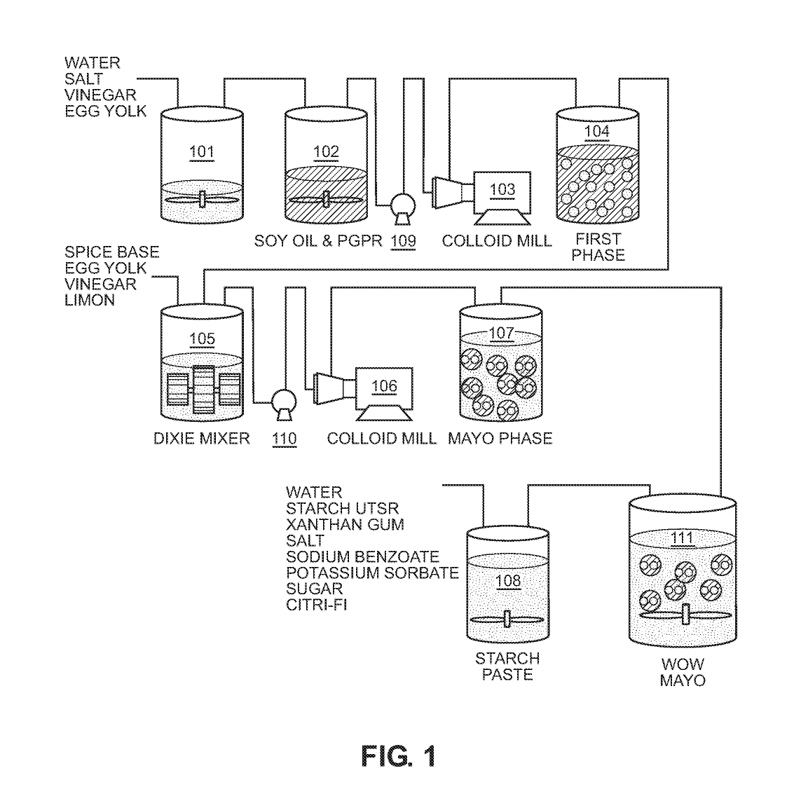

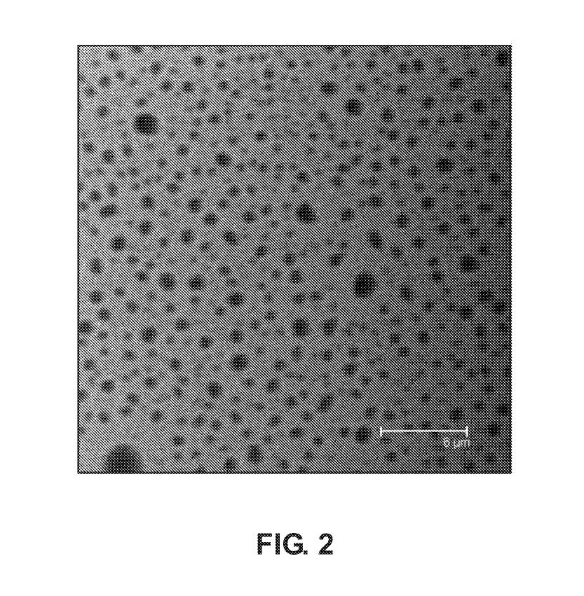

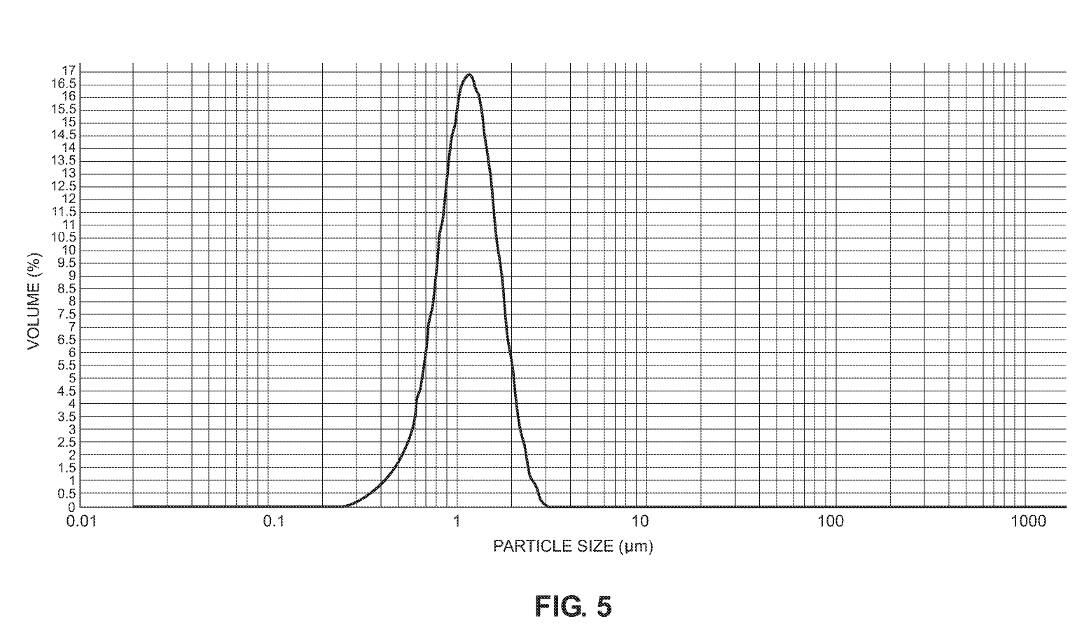

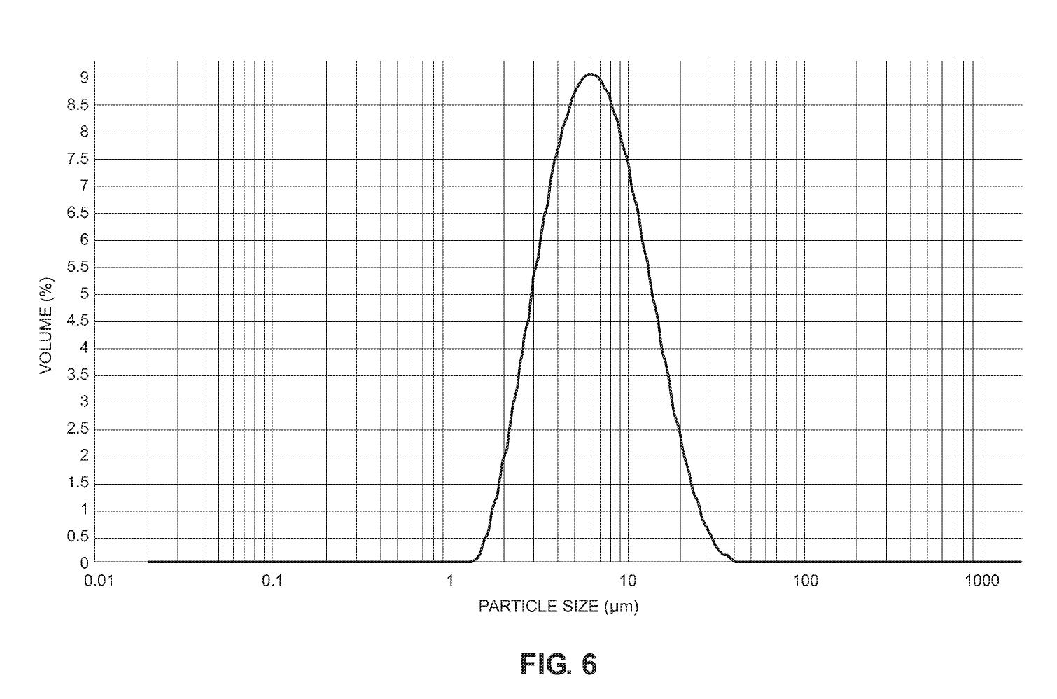

As demonstrated in FIG. 1, a first phase of ingredients is prepared by adding polyglycerol polyricinoleate (PGPR) to a suitable edible oil, typically a vegetable oil such as soy oil (102), sun flower oil, canola oil, olive oil, etc. The mixture of hydrocolloids such as dairy protein, vegetable protein and plant protein, whey protein isolate; soy, egg or milk lecithins; pectin, gum (locust bean gum, gum arabic, guar gum, Konjac gum, xanthan gum, alginates, carrageenans); starches, modified starches, cellulose, modified cellulose; and/or fibers, fruit fibers, cereal fibers, vegetable fibers, etc. and salt (e.g., conventional salts such sodium chloride, potassium chloride, etc.), and optionally egg yolk (enzyme modified egg yolk and whole egg containing its yolk can also be used) is then also added to the water (101), and the water mixture slowly added to the oil phase with agitation (as is common practice in the area of food and food preparation, it is important that the materials to be blended are added in a way so as to produce a continuous change of state of the materials being combined, i.e., not to just dump the materials together; conventional controlled mixing or agitation similarly contributes to this goal). This is followed by the addition of vinegar to the water-oil mixture. Vinegar also can be added to the above water mixture and the mixture is then slowly added to the oil phase. This mixture is pre-emulsified to a water/oil (w/o) emulsion in a conventional mixer (102), is then pumped (109) through a colloid mill (103) with appropriate rpm (revolutions per minute), gap, and feed rate to produce a stable first phase. See FIG. 5, for example, which shows typical particle size distribution of the water droplets in the first emulsion (droplet size measured on Malvern Mastersizer 2000) and FIG. 6 which shows typical particle size distribution of the oil droplets in the double emulsion. See also FIG. 2 which shows a confocal picture (confocal photo taken with a Leica TCS SL Confocal Scanner) of a typical first emulsion (the black dots are the water droplets, red color represents oil phase). Total water content in the first phase water in oil emulsion (104) is typically up to about 45% by volume. The water droplets in the first emulsion are primarily (>90%) water, but of course also contain minor amounts of other materials such as fibers, hydrocolloids, salt, vinegar, egg yolk, etc. as described herein.

The above settings, which can vary depending on the specific equipment being used, are adjusted to produce a target size of the water droplets in the first emulsion which at this point are about 0.5 to 3 μm (micron) (e.g., 0.5, 1.0, 1.5, 2.0, 2.5, 3). For example, using a Charlotte SD2 (Chemicolloid Laboratories, Inc. New York) colloid mill, rpm between 3000 and 6000, gap between 0.2 and 2mm (millimeter), and feed rate between 300 and 1500 kg/hr (kilograms per hour) have been found to produce the target particle size desired. The desired particle size can also be produced by a single pass through the colloid mill, or by multiple passes, depending on the equipment and settings used.

Following production of the first emulsion, flavoring agents (i.e., spice base, conventional flavorings and/or spices) and egg yolk are added to a Dixie mixer (105), followed by slow addition of the first emulsion prepared as described above, and including the addition of vinegar, and optionally lemon or lime juice, and the additional flavorings and spice base materials such as conventional spices and flavorings, e.g., mustard seed, pepper, etc. It is important to control the process temperature at 4° C. to about 20° C. and 10° C. is preferred. The water in oil emulsion needs to be cooled if it's above 20° C. It is also helpful to use ingredients, especially oil and egg yolk below 10° C. to facilitate the emulsion formation when preparing mayonnaise.

This mixture is pumped (110) through a colloid mill (106), again with appropriate settings, including rpm, gap, feed rate and temperature, to produce a double emulsion (107). Again, as above, the desired particle size can also be produced by a single pass through the colloid mill, or by multiple passes, depending on the equipment and settings used. FIG. 3 shows a typical confocal picture of this double emulsion (the black indicating water, and the red oil)

One or more hydrocolloids, such as one or more fibers, gums and/or starches including modified starch, is pre-mixed with other dry ingredients including salt, sugar, and preservatives (e.g., typical condiment preservatives such as sodium benzoate, potassium sorbate, EDTA, etc.), are hydrated/dispersed into water with high shear (conventional mixer, shear determined by mixing speed) to produce a starch paste (108) or solution prior to introduction into the second phase oil in water (107) emulsion. Typically enough water is added to the starch (or other hydrocolloid) to produce a paste having a viscosity of about 100,000 to 200,000 centipoise. The pre-hydrated starch paste mixture is gently mixed into the mayonnaise phase to create the final product (111). The desired viscosity is obtained (typically about 150,000 centipoise (cP)) and the double emulsion structure also preserved.

The hydrocolloids mentioned above can include such things as dairy protein, vegetable protein and plant protein, such as whey protein isolate; soy, egg or milk lecithins; pectin, gum (locust bean gum, gum arabic, guar gum, Konjac gum, xanthan gum, alginates, carrageenans); starches, modified starches, cellulose, modified cellulose; and/or fibers, fruit fibers, cereal fibers, vegetable fibers, etc.

In the first emulsion, the water droplets produced typically have a diameter of about 0.5 to about 3 microns (μm) as described above (e.g., 0.5 μm, 1 μm, 1.5 μm, 2 μm, 2.5 μm, 3 μm). In preparing the double emulsion, the above equipment settings, which as stated can vary depending on the specific equipment being used, are adjusted to produce a target size of the oil droplets at this point (oil droplets in the double emulsion) of about 5 μm to about 15 μm (e.g., 5 μm, 6 μm, 7 μm, 8 μm, 9 μm, 10 μm, 11 μm, 12 μm, 13 μm, 14 μm, 15 μm). In the double emulsion part of the process, for example, using a Charlotte SD2 (Chemicolloid Laboratories, Inc. New York) colloid mill, rpm between 3000 and 6000, gap between 0.2 and 2 mm (millimeter), the feed rate range can also be expanded to 300 to 1500 kg/hr.

The oil content of the products produced are typically less than 65% by weight, e.g., 40% or less, 30% or less, and 20% by weight, or lower. When reduced fat mayonnaise is produced as described herein, the shelf life is at least as long as it's full-fat commercially available counterparts, i.e., products containing greater than 65% oil. The products produced by the processes described herein also maintain their high viscosity, suffer substantially no oil-water phase separation, microbial growth, or oxidation. And sensory descriptive analysis has demonstrated that, in spite of the reduced oil content, the condiments produced maintain an enhanced taste profile, substantially the same as their non-reduced fat counterparts.

Citrus fiber can be introduced into the system in both first emulsion and double emulsion portions of the process. It increases the viscosity of the final product, stabilizes the w/o/w structure, and gives a better mouth feel, among other things. The estimated shelf life of the finished product should typically be the same as commercially available full fat mayonnaise. The product and processes described herein present a practical way to use w/o/w technology in reduced fat mayonnaise production. The whole design is relatively easy to implement. Another one of the very surprising results, for example, is that the 20% fat containing mayonnaise made as described herein tastes more like 75% fat containing mayonnaise as compared with 40% fat containing mayonnaise, for example, made with current technology. Compared with current low fat mayonnaises technology, this process can produce much lower fat content (20% fat or lower fat) mayonnaise, at relatively low cost with better sensory results, i.e., low oil content, good shelf stability and organoleptic properties.

While the amounts of materials used in the above example can vary according to the taste profile desired, viscosity desired, microbial stability desired, whether the target product is sauce, dressing, sandwich spread, tartar sauce, mayonnaise, etc., a representative formulation could include (percents by weight) water in the range of about 50% to about 60%, soybean oil in the range of about 15% to about 40%, vinegar in the range of about 5% to about 10%, egg yolk in the range of about 3% to about 10%, salt in the range of about 2% to about 5%, sugar in the range of about 2% to about 5%, modified starch in the range of about 2% to about 5%, flavoring agents in the range of about 1% to about 3%, fiber up to about 2%, xanthan gum up to about 0.5%, and PGPR in the range of about 0.15% to about 0.28%. It should be noted that in addition to, or in place of, PGPR, other emulsifiers with relatively low HLB values (hydrophilic-lipophilic balance) can also be used. For example, HLB numbers for the water in oil emulsion (1st phase) formation is typically from about 2 to about 6. As such, other emulsifiers that can be used include such things as sorbitan monooleate, sorbitan sesquioleate, sorbitan esters with HLB from about 2 to about 6, glycerol monostearate, sorbitan tristerate, propylene glycol monostearate, lecithin, ammonium phosphatide, sucrose ester, etc.

One of the benefits of the double emulsion processes described herein, is the shelf stable, higher viscosities that can be attained with these reduced fat products (again, as described above). This is another reason for the enhanced organoleptic properties attained in these products as well, e.g., taste similar to full-fat commercially available mayonnaise, and reduced fat, yet creamy salad (e.g., Caesar) dressings, sauces, tartar sauce, sandwich spreads, etc.

It is also well known in this environment, that acid content in the product (e.g., vinegar) helps to prevents spoilage—but also affects taste expectations. As in conventional products, this acid is generally present in the water phase. But in the products and processes described herein, additional acid over and above that present in conventional products, can be present inside the water droplets produced in the first emulsion, but because of the double emulsion structure of the final product, has a delayed release when consumed, which results in enhanced shelf stability over other reduced fat products, but with no significant adverse effects on the taste profile.

It is noteworthy that the benefits described herein, including for example, a spread such as mayonnaise with a fat content of 20% (or lower) (which also represents at least a 50% reduction in commercially available reduced fat products), and a viscosity of at least 150,000 centipoise, can be attained with a PGPR content as low as 0.28% by weight.

It is also particularly important to note that, in order to attain the advantageous properties described herein in the final product, such as viscosity, texture, etc., not only is the shear rate the specific compositions are subjected to important, but the selection of the apparatus to produce the specific particle sizes described herein of both the water droplets in the oil in the first phase, and the oil droplets in the water in the second phase, is important as well, i.e., how the shear is imparted to generate the particles sizes desired, is also very important, both to the process and the resultant produce. Shear rates of about 1×10³ s⁻¹ to about 1×10⁶ s⁻¹ (reciprocal seconds) with residence time of less than 3 seconds can be used to produce the desired water droplet size and viscosity, etc. of the first (water droplets in oil) phase, and shear rates of about 1×10³ s⁻¹ to about 1×10⁶ s⁻¹ with residence time of less than 3 seconds can be used to produce the desired oil droplet size and viscosity, etc. of the second (oil droplets in water, actually WOW) phase.

Obviously, ranges within these ranges can also be used, e.g. about 1.3×10⁴ s⁻¹ to about 9.9×10⁴ s⁻¹ with residence time of less than 1 second for the first phase, and about 1.2×10⁴ s⁻¹ to about 4.7×10⁴ s⁻¹ with residence time of less than 1 second for the second phase. It is particularly desirable to single pass process, while multiple passes of the materials through the apparatus can also be used, either by batch recycling, continuous recirculation through the shear apparatus, or by passage through multiple shear apparatus in series. It is the combination of the residence time and shear rate that will determine the particle size. For example, using an IKA Pilot 2000/4 (IKA Works Inc, Wilmington, N.C.) colloid mill, e.g. shear rate about 5×10⁴ s⁻¹ to about 7×10⁴ s⁻¹ for the first phase, single pass process can reach the target particle size with residence time about 0.1 second. To reach the same particle size target, using a Charlotte SD2 (Chemicolloid Laboratories, Inc. New York) colloid mill, the shear rate is about 1.3×10⁴ s¹ to about 2.7×10⁴ s⁻¹ with total residence time of about 0.3 seconds from multiple passes.

While these numbers might vary from one shear machine to another, target particle size and desired viscosity is of course the goal. And as mentioned above, it has been found that, in order to attain the advantageous properties described herein not only is the shear rate the specific compositions are subjected to important, but the selection of the apparatus to produce the specific particle sizes described herein is important as well. For example, even though homogenizers can produce shear rates as described herein, it has been found that the use of rotor stator shear devices are desirable to not only produce the required particle sizes of the emulsions described herein at the viscosities described herein, but with the emulsion stability and organoleptic properties required as well. Apparatus particularly useful can include colloid mills and high shear mixers from Silverson, Quadro, Admix, Arde-Barinco, IKA, Fryma and Polytron, for example.

It is also particularly noteworthy to observe the following. While other condiment processes and compositions use emulsifiers such as PGPR, they are typically required to be used in much higher amounts, for example, about 4% to about 8% by weight. The compositions and processes described herein, generate stable emulsions at much lower PGPR levels, for example, far below even 1%. It is also noteworthy that the inclusion of vinegar in the water droplets present in the oil emulsion of the first phase not only helps with controlling microbe stability, but helps with emulsification and emulsification stability as well. The presence of the vinegar helps the generation of the small particle size, and particle size stability as well (i.e., small stable particles as described herein).

Water management (e.g., osmotic pressures) in the processes and compositions described herein, e.g., in the droplets formed and in the emulsions, is also important to note. For example, as depicted in FIG. 1, the materials added at the end of the process, at 108 in FIG. 1, are mixed dry and then hydrated, i.e., added to and mixed in water, before the material 108 is added to form the final product 111. If the materials are added dry, and directly in the final step, they could potentially pull the water out of the WOW emulsified droplets and disrupt the important water management (insuring sufficient water availability at each step of the process) in the process and compositions described herein. So again, not only are the specific materials described herein important to attain the stability, organoleptic properties, reduced fat content, etc. described herein, but the process of addition of these materials is important as well. It is also important to note that the use of the water in oil in water emulsions described herein, for example, for fat reduction, as opposed to just adding starch or gum, for example, and removing oil, are such things as excellent flavor delivery and texture such as creaminess which are at least the same as in full fat mayonnaise, for example.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of making reduced fat condiments comprising,
preparing a stable water in oil emulsion comprising
adding an emulsifier to an edible oil,
adding salt and optionally thickeners and/or optionally egg yolk to water,
adding the water mixture to the oil mixture,
adding vinegar to the water mixture either before combining with the oil mixture, and/or to the combined water-oil mixture and
processing the water-oil mixture in at least one rotor stator mixer to produce a stable water in oil emulsion,
preparing a stable water in oil in water emulsion, comprising
mixing a composition comprising egg yolk and vinegar with the stable water in oil emulsion, and
processing the mixture through at least one rotor stator mixer to produce a stable water in oil in water emulsion containing the stable water in oil emulsion,
preparing a hydrated hydrocolloid paste composition, comprising
mixing the hydrocolloid composition with water to produce a hydrated hydrocolloid paste composition,
mixing the hydrated hydrocolloid paste composition with the stable water in oil in water emulsion,
resulting in a reduced fat, shelf stable condiment with enhanced organoleptic properties.

2. The method of claim 1, wherein the thickeners comprise edible fibers and/or xanthan gum.

3. The method of claim 1, wherein the rotor stator mixer is a colloid mill.

4. The method of claim 1, wherein the emulsifier is polyglycerol polyricinoleate, sorbitan monooleate, sorbitan sesquioleate, sorbitan esters with HLB from about 2 to about 6, glycerol monostearate, sorbitan tristerate, propylene glycol monostearate, lecithin, ammonium phosphatide, and/or sucrose ester.

5. The method of claim 1 wherein the stable water in oil emulsion is formed by shearing the water-oil mixture in the at least one rotor stator mixer at a shear rate of about 1×103 s−1 to about 1×106 s−1 with residence time of less than 3 seconds.

6-8. (canceled)

9. The process of claim 1, wherein flavoring agents are added after preparation of the water in oil emulsion.

10. The process of claim 9, wherein the flavoring agents include citrus flavoring agents.

11. The process of claim 10, wherein the citrus flavoring agents comprise lemon juice or lime juice.

12. The process of claim 1, wherein the condiment is a reduced fat mayonnaise having a viscosity of about 100,000 to about 200,000 centipoise.

13-14. (canceled)

15. The process of claim 1, wherein the condiment is a reduced fat dressing or sauce having a viscosity of below about 60,000 centipoise.

16-17. (canceled)

18. The process of claim 15, wherein the dressing or sauce is a reduced fat salad dressing, sandwich spread, or tartar sauce.

19-20. (canceled)

21. The process of claim 1, wherein the edible fiber is citrus fiber.

22. The process of claim 1, wherein the hydrocolloid is a modified starch.

23. The process of claim 1, wherein the hydrocolloid comprises one or more fibers, gums and/or starches.

24. The process of claim 1, wherein the hydrated hydrocolloid paste additionally contains salt, sugar, citrus fiber and/or preservatives.

25. The process of claim 1 wherein the stable water in oil emulsion contains water droplets have an average diameter of about 0.5 micron to about 3 microns.

26. The process of claim 1 wherein the water in oil in water emulsion contains oil droplets having an average diameter of about 5 microns to about 15 microns.

27. The process of claim 1, wherein the condiment produced has an oil content of less than 65% by weight.

28-33. (canceled)

34. The process of claim 1, wherein the condiment is mayonnaise, having a viscosity of about 150,000 centipoise, the oil is present in an amount of about 20% by weight, and the emulsifier is polyglycerol polyricinoleate present in an amount of about 0.15% to 0.28% by weight.

35. A reduced fat condiment product produced by the process of claim 1.
